(19) United States
(12) Patent Application Publication
(10) Pub. No.: US 2007/0132250 A1
(43) Pub. Date: Jun. 14, 2007

(54) Use of an intumescent material and device having a material of this type

(76) Inventor: Rudolf Schnekenburger, Dellingen (DE)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 10/574,658

(22) PCT Filed: Oct. 8, 2004
(86) PCT No.: PCT/EP04/11306

§ 371 Date: Dec. 29, 2006

(30) Foreign Application Priority Data
Oct. 9, 2003 (DE) 103-47-027.1

(51) Int. Cl. E05C 1/06

(52) U.S. Cl. 292/144

(57) ABSTRACT

The present invention relates to the use of an intumescent material as a sensor, actuator, and fixing means for movable elements in the field of fire and smoke protection.

The present invention relates to the use of an intumescent material and devices having a material of this type.

Intumescent material is known in principle in the field of fire protection from DE 19653503 A1, for example. This is a flexible insulating layer producer, based on expanded graphite, for example, which expands under the effect of temperature. It is offered as a roll material, as prepared strips, blanks, or stamped parts for use for fire protection doors, fire protection glass, facades, safes, cable and pipeline bushings, etc. In the following, it is referred to in short as intumescent material or simply as material.

Commercially available material is between 1.5 and 6.5 mm thick. Typical reaction temperatures are above 170° C. The foaming behavior is three-dimensional, the foam height being able to increase with increasing temperature at very high expansion pressure up to 45 times the starting volume. The expansion pressure is at least 0.8 N/mm². The known applications are exhausted in sealing and/or covering passages, gaps, and slots, as well as walls, with a protective layer in case of fire. For example, in fire protection doors, the material is glued to the door frames.

The present invention is based on the object of further improving devices in connection with fire alarms, fire prevention, personal protection, and asset protection for use in case of fire hazard.

This object is alternatively achieved via the following uses and devices. In this case, for all uses and devices, by predefining the expansion temperature, the reaction temperature may be set, the expansion temperature in turn being a function of the components of the material used. An adaptation to the intended purpose may thus be performed.

A first achievement of the object is the use of an intumescent material as a sensor for a fire alarm. The temperature-dependent expansion of the material is the criterion that a fire has broken out in this case.

A second achievement of the object is the use of an intumescent material as the actuator of a fire alarm. The material triggers a switch upon expansion, which in turn triggers an alarm signal.

A preferred refinement of the second achievement of the object is that the fire protection device is a door opener or a lock, and the intumescent material is operatively linked to at least one of the door opener components of armature, changeover switch, or latch or one of the lock components of latch, handle socket, bolt, or bolt drive. This has the advantage that movable parts relevant for the door opener function or lock function may have intumescent material applied to them directly, so that a predefined state may be reliably assumed or maintained in case of fire.

The security of fire protection doors may be significantly increased using the present invention. Fire protection doors are known to have the object of separating two fire sections. They fire protection door must therefore be safely and reliably “closed” in case of fire, but may not be locked. Furthermore, it is to be considered that large forces may act on the restraint due to high temperatures acting on one side. The present invention counters the danger that in case of fire the door opener or the lock opens due to electronic malfunction or due to burning out, deformation as a result of heat, etc.

Specifically, the present invention prevents the armature from being able to be deflected for indirect or direct release of the pivoting latch in a door opener. A door opener is especially safe if the changeover switch and/or the pivoting latch itself may additionally or alternatively have intumescent material applied to it. This advantage particularly applies if the armature or the changeover switch releases the changeover switch against gravity. Due to the effect of heat, the armature spring may burn out and the armature may thus release the changeover switch under the effect of gravity.

The advantages of the present invention apply in particular where electromechanically actuated elements or elements driven by a motor are activated by an electronic controller. This controller may break down in case of fire, while the activation voltage of the motor or the electromechanical actuation is still maintained and thus results in an actuation or drive of the element. The intumescent material moves the locking element against the electromechanical actuators here.

A third achievement of the object is the use of an intumescent material as a status documentation means of a current status of an element or a device in case of fire. Status documentation devices of this type are required, for example, for ascertaining the cause of fire in a device or building. For this purpose, for example, the status of display elements, actuating elements, etc. is to be fixed in the position in which the fire has broken out. The situation existing upon fire outbreak is more or less “frozen”.

An expedient refinement of the fourth achievement of the object is that the element whose status is to be documented in case of fire is at least partially covered or completely enclosed by intumescent material through the effect of heat. This has the advantage that multiple parts of a device may be protected from the fire for later evaluation.

A fifth achievement of the object is an adjustment device in case of a fire having at least two elements, whose relative position is adjustable to one another, in that an intumescent material is operatively linked to at least one of the element in such a way that the intumescent material changes the relative position through its shape change. A fire sensor or a fire alarm may thus be produced in a simple way.

A sixth achievement of the object comprises a fixing device having at least two elements, whose relative position to one another is adjustable, in that an intumescent material is operatively linked to at least one of the elements in such a way that the intumescent material fixes the relative position through its shape change. Using a device of this type, for example, mechanical access control devices, such as door openers, locks, retaining devices, etc., may be equipped in such a way that they assume a predefined state in case of fire. Depending on the application, it may be desirable for an access to be closed or a door or a window to be released.

A preferred refinement of the sixth solution is that two elements adjustable in relation to one another are provided, one element being adjustable and the other element being fixed in place.

A seventh achievement of the object exists in a door or a window having at least one bolt, in that an intumescent material is operatively linked to the bolt in such a way that the intumescent material fixes the bolt in its current position through its shape change.

An eighth achievement of the object exists in a lock/release device for use in a door or a window having at least one bolt, in that an intumescent material is operatively linked to the bolt in such a way that the intumescent material moves the bolt into a predefined position (lock or release) through its shape change.

A ninth achievement of the object exists in an immobilizing system for fire protection and smoke protection doors as well as fire protection and smoke protection windows, fire protection flaps, or smoke dispersal flaps, in which the intumescent material actuates or triggers an immobilizing mechanism.

A tenth achievement of the object exists in a lock/release device for use in a door opener, in general at least one armature and one latch being provided as elements adjustable in relation to one another, in that an intumescent material is positioned in such a way that its shape change changes and/or fixes the relative position of at least one adjustable element, and thus brings the door opener into a predefined position and/or keeps it in a predefined position.

A preferred refinement of the tenth achievement of the object is that the predefined position is a lock or release position.

Furthermore, is expedient for this purpose for the intumescent material to be positioned at a rotation point of the adjustable element in the starting state.

Moreover, it may be advantageous for the intumescent material to be positioned at a free end of the adjustable element in the starting state.

The intumescent material is advantageously positioned within a device housing to fill up the free space in the starting state.

In principle, the intumescent material may be positioned on a movable part. However, it has been shown to be expedient for the intumescent material to be positioned on a housing wall as the position-fixed element in proximity to the adjustable element in the starting state.

It is advantageous for the intumescent material to be positioned in a recess of the housing wall in the starting state, because it may be easily attached reliably there, by gluing or clamping, for example.

In the following, the present invention will be described further on the basis of two exemplary embodiments illustrated in the drawing.

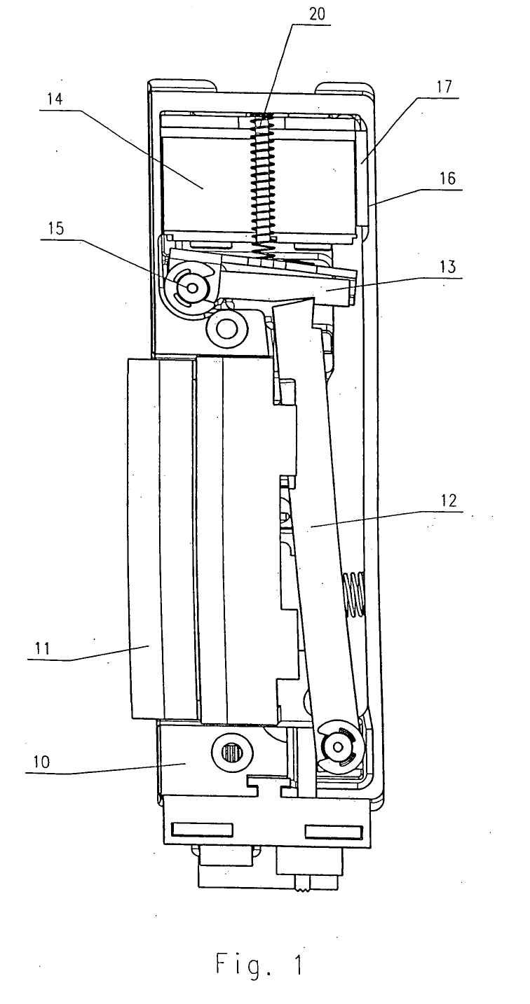

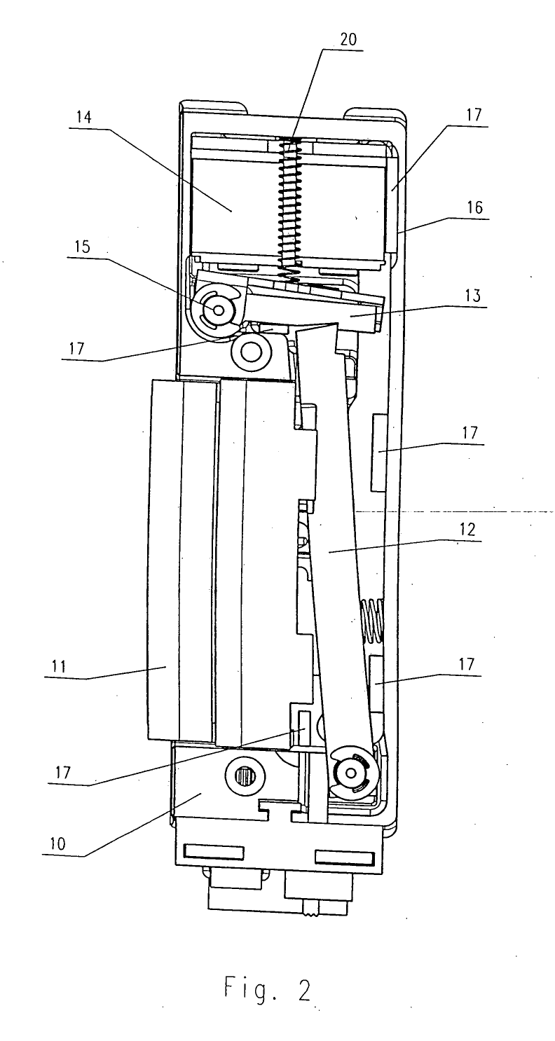

FIG. 1 and FIG. 2 each schematically show across section through a door opener.

As shown in FIG. 1, a door opener in a housing 10 has a pivot latch 11, a changeover switch 12, and an armature 13, implemented as a changeover lock, having a coil 14 of an electromagnet. The armature 13 is implemented as a pivot lever on a joint 15 and is pre-tensioned using an armature spring 20 in such a way that it is held in its locking position, which is shown in the figure. When current is applied to the coil 14, the armature 13 is pulled into its unlocking position against the spring action, so that the changeover switch 12 releases the pivot latch 11.

An intumescent material 17 is positioned in a recess 16 on an inner wall of the housing 10 in proximity to the armature 13 in such a way that it fills up the free space of the housing in the area of the armature 13 through its volume expansion, and permanently embeds the armature 13 in the locking position at the same time. In the example shown, the intumescent material 17 is positioned in the area of the free end of the armature 13, so that the expansion pressure acts on the long lever arm of the armature 13. The intumescent material 17 is glued to the housing wall.

In case of fire, when the expansion temperature has been reached and the intumescent material expands, it presses against the armature 13 and holds it in its locking position independently of the action of the armature spring 20. The pivot latch 11 therefore remains locked, even if the armature spring 20 burns out. The armature is more or less “frozen” in the locking position. This is true even if the door opener is installed rotated by 180° and the armature spring 20 presses the armature 13 into the locking position against its own weight.

In the exemplary embodiment of a further door opener shown in FIG. 2, identical parts as in FIG. 1 are provided with identical reference numbers. In addition, additional arrangements 17′ of intumescent material are provided in further free spaces inside the housing 10, particularly in the area of the movable parts, such as pivot latch 11 and changeover switch 12. Under the effect of heat, they fill up the free spaces and block the movement of the affected parts. The door opener is thus additionally secured against opening.

1. A use of an intumescent material as a sensor for a fire alarm.

2. A use of an intumescent material as an actuator of a fire alarm.

3. A use of an intumescent material as an actuator of a fire protection device.

4. The use of an intumescent material according to claim 3,
wherein the fire protection device is a door opener or a lock, and the intumescent material is operatively linked to at least one of the door opener components armature or latch and/or to at least one of the lock components latch, handle socket, bolt, or bolt drive.

5. A use of an intumescent material as a status documentation means of a current status of an element of a device in case of fire.

6. The use according to claim 6,
wherein the element whose status is to be documented in case of fire is at least partially covered or completely enclosed by the intumescent material under the effect of heat.

7. An adjustment device in case of fire having at least two elements, whose relative position to one another is adjustable,
wherein the intumescent material is operatively linked to at least one of the elements in such way that the intumescent material changes the relative position through its shape change.

8. A fixing device having at least two elements, whose relative position to one another is adjustable,
wherein an intumescent material is operatively linked to at least one of the elements in such way that the intumescent material fixes the relative position through its shape change.

9. The device according to claim 7,
wherein the intumescent material is operatively linked to the elements adjustable in relation to one another by its shape change.

10. The device according to claim 7,
wherein two elements adjustable in relation to one another are provided, one element being adjustable and the other element being fixed in position.

11. A lock/release device for use in a door or a window having at least one bolt,
wherein an intumescent material is operatively linked to the bolt in such way that the intumescent material fixes the bolt in its current position through its shape change.

12. A lock/release device for use in a door or window having at least one bolt,
wherein an intumescent material is operatively linked to the bolt in such way that the intumescent material moves the bolt into a predefined position (lock or release) through its shape change.

13. A lock/release device for use in a door opener, at least one armature and a latch being provided as elements adjustable in relation to one another,
wherein an intumescent material is positioned in such way that its shape change changes and/or fixes the relative position of at least one adjustable element, and thus brings the door opener into a predefined position and/or keeps it in a predefined position.

14. The lock/release device according to claim 12,
wherein the predefined position is a lock or a release position.

15. The device according to claim 7,
wherein the intumescent material is positioned on a rotation point of the adjustable element in the starting state.

16. The device according to claim 7,
wherein the intumescent material is positioned on a free end of the adjustable element in the starting state.

17. The device according to claim 7,
wherein the intumescent material is positioned inside a device housing to fill up the free space in the starting state.

18. The device according to claim 17,
wherein the intumescent material is positioned, as the element fixed in position, on a housing wall in proximity to the adjustable element in the starting state.

19. The device according to claim 18,
wherein the intumescent material is positioned in a recess of the housing wall in the starting state.

20. An immobilizing system for fire protection and smoke protection doors as well as fire protection and spoke protection windows, fire protection flaps, or smoke dispersal flaps,
wherein the intumescent material actuates or triggers an immobilizing mechanism.
